(19) United States
(12) Patent Application Publication
(10) Pub. No.: US 2026/0230205 A1
(43) Pub. Date: Aug. 6, 2026

(54) METHODS FOR INTERFERENCE PLUS NOISE REPORTING

(71) Applicant: Telefonaktiebolaget LM Ericsson (publ), Stockholm (SE)

(72) Inventors: Mattias FRENNE, Uppsala (SE); Claes TIDESTAV, Bålsta (SE)

(21) Appl. No.: 19/152,759

(22) PCT Filed: Feb. 2, 2024
(86) PCT No.: PCT/SE2024/050095

§ 371 Date: Jul. 31, 2025

Related U.S. Application Data
(60) Provisional application No. 63/482,909, filed on Feb. 2, 2023.

(51) Int. Cl. H04B 17/345; H04B 17/309

(52) U.S. Cl. CPC H04B 17/345; H04B 17/346

(57) ABSTRACT

A method, system and apparatus are disclosed, a method in a wireless device (WD) configured to communicate with a network node is described. The method includes receiving a first configuration for an interference plus noise (IpN) measurement associated with a first channel, receiving a data transmission from the network node on the first channel, and transmitting a first measurement report to the network node. The first measurement report is based on the first configuration and the data transmission from the network node on the first channel. Further, the first measurement report includes the IpN measurement associated with the first channel.

### TECHNICAL FIELD

The present disclosure relates to wireless communications, and in particular, to interference plus noise (IpN) reporting in a wireless communication network.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD) (e.g., user equipment (UE)), as well as communication between network nodes and between WDs. The 3GPP is also developing standards for Sixth Generation (6G) wireless communication networks.

### Channel State Information (CSI) and CSI Feedback

A core component in LTE and NR is the support of multiple input multiple output (MIMO) antenna deployments and MIMO related techniques. Spatial multiplexing is one of the MIMO techniques used to achieve high data rates in favourable channel conditions.

For an antenna array with N_{T} antenna ports at the network node (e.g., gNB) for transmitting r downlink (DL) symbols s=[s₁, s₂, . . . , sᵣ]^{T}, the received signal at a wireless device (e.g., UE) with N_{R} receive antennas at a certain resource element (RE) n can be expressed as

$${y}_{n} = {H}_{n} Ws + {e}_{n}$$

where yₙ is a N_{R}×1 received signal vector; Hₙ is a N_{R}×N_{T} channel matrix at the RE between the network node and the wireless device; W is an N_{T}×r precoder matrix; eₙ is a N_{R}×1 noise plus interference vector received at the RE by the wireless device. The precoder W can be a wideband precoder, i.e., constant over a whole bandwidth part (BWP), or a subband precoder, i.e., constant over each subband.

The precoder matrix is typically selected from a codebook of possible precoder matrices, and typically reported by a precoder matrix indicator (PMI), which specifies a unique precoder matrix in the codebook for a given number of symbol streams. Each of the r symbols in s corresponds to a spatial layer, and r is referred to as the rank of the channel and is reported by a rank indicator (RI).

For a given block error rate (BLER), a modulation level and coding scheme (MCS) is determined by a wireless device based on the observed signal to noise and interference ratio (SINR), which is reported by a channel quality indicator (CQI). NR supports transmission of either one or two transport blocks (TBs) to a wireless device (UE) in a slot, depending on the rank. One TB is used for ranks 1 to 4, and two TBs are used for ranks 5 to 8. A CQI is associated to each TB. The CQI/RI/PMI report can be either wideband or subband based on configuration.

RI, PMI, and CQI are part of channel state information (CSI) and reported by a wireless device to a network node (e.g., gNB).

### Channel State Information Reference Signal (CSI-RS) and CSI-IM

A CSI-RS is transmitted on each transmit antenna port and is used by a wireless device to measure downlink channel associated with each of antenna ports. The antenna ports are also referred to as CSI-RS ports. Typically, the supported number of antenna ports in NR are {1, 2, 4, 8, 12, 16, 24, 32}. By measuring the received CSI-RS, a wireless device can estimate the channel the CSI-RS is traversing, including the radio propagation channel and antenna gains. CSI-RS for this purpose is also referred to as Non-Zero Power (NZP) CSI-RS.

NZP CSI-RS can be configured to be transmitted in certain Res per physical resource block (PRB). FIG. 1 illustrates an example of a NZP CSI-RS resource configuration with four CSI-RS ports in a PRB in one slot.

In addition to NZP CSI-RS, Zero Power (ZP) CSI-RS has been defined in NR to indicate to a wireless device that the associated Res are not available for physical downlink shared channel (PDSCH) scheduling at the network node (e.g., gNB). ZP CSI-RS may have the same RE patterns as NZP CSI-RS.

CSI resource for interference measurement (CSI-IM) is also defined in NR for a wireless device to measure noise and interference, typically from other cells. This measurement is used to estimate the CQI for the CSI report.

CSI-IM may comprise of four Res in a slot. Two different CSI-IM patterns may be defined, e.g., where the CSI-IM pattern can be either four consecutive Res in one orthogonal frequency division multiplexing (OFDM) symbol or two consecutive REs in both frequency and time domains. An example is shown in FIG. 1. Typically, a network node (e.g., gNB) does not transmit any signal in the CSI-IM resource, so that what observed in the resource is noise and interference from other cells.

Further, existing NR specifications have only defined a CSI-IM resource for CSI reporting. Some existing systems provide no definition of how the wireless device may measure interference when receiving a downlink data or control channel (PDSCH and physical downlink control channel (PDCCH), respectively).

In some existing systems, the CQI is time varying, sometimes very rapidly which degrades link adaptation performance since, when the CQI is to be used, the reported value is already outdated if the SINR art the wireless device has changed. A potential remedy is to use very frequent CSI-RS measurements and CSI reports to try to track the SINR variations. However, this leads to significant overhead, which may negatively impact performance.

### SUMMARY

Some embodiments advantageously provide methods, systems, and apparatuses for interference plus noise (IpN) reporting in a wireless communication network that is more efficient than in current arrangements.

The present disclosure describes embodiments which take advantage of interference often being much more rapidly varying compared to the fading of the desired channel. Hence, embodiments of the present disclosure describe a separate IpN report where the IpN may be estimated by the wireless device at PDSCH reception occasions. Since the PDSCH may be received much more frequently (e.g., every slot) than the CSI-RS (e.g., every 10th slot), embodiments of the present disclosure describe an IpN report associated with a measurement during the PDSCH reception.

Some embodiments provide configuration of a measurement and a reporting of the interference and noise power, where the measurement is made in association with a PDSCH reception. For example, embodiments may utilize a measurement of IpN on the residual of the DMRS associated with the PDSCH or measurements on a dedicated interference measurement resource (IMR) that is defined for the PDSCH demodulation.

On the network side, the IpN measurements from the PDSCH may be combined with other CQI reports (e.g., in the network node, gNB, etc.) to improve the accuracy of the network side estimated CQI (e.g., as estimated at the network node, gNB, etc.).

Embodiments of the present disclosure may advantageously provide more accurate CQI, compared to some existing solutions, which may improve the link adaptation, improves spectral efficiency, etc., and with reduced signalling overhead, e.g., without introducing new transmissions from the network or network node or from the wireless device.

According to an aspect, a method in a wireless device (WD) configured to communicate with a network node is described. The method includes receiving a first configuration for an interference plus noise (IpN) measurement associated with a first channel, receiving a data transmission from the network node on the first channel, and transmitting a first measurement report to the network node. The first measurement report is based on the first configuration and the data transmission from the network node on the first channel. Further, the first measurement report includes the IpN measurement associated with the first channel.

In some embodiments, the first configuration includes an interference measurement resource (IMR) for reception of the first channel.

In some other embodiments, the method further includes performing the IpN measurement on the IMR.

In some embodiments, one or both of the IMR configures residual demodulation reference signal (DMRS), and the method further includes when the WD has performed a channel estimation on the DMRS associated with the first channel, estimating the IpN on one or more DMRS resources.

In some other embodiments, the IpN measurement is a power measurement of received power in one or more empty resource elements in a resource allocation of the first channel.

In some embodiments, the received power is normalized with respect to another measurement that reflects a desired channel.

In some other embodiments, the method further includes one or more of: (A) determining the first measurement report based on the first configuration and the data transmission from the network node on the first channel; (B) transmitting the IpN measurement to the network node in an uplink report; (C) transmitting the IpN measurement to the network node as uplink control information in one or both of a physical uplink control channel and a physical uplink shared channel; and (D) transmitting the IpN measurement together with acknowledgement information of the first channel.

In some embodiments, the IpN measurement corresponds to an entire bandwidth of the first channel or a plurality of bandwidth parts of the first channel.

In some other embodiments, the method further includes receiving a second configuration of channel state information measurement and reporting and transmitting a channel state information (CSI) report based on the second configuration.

In some embodiments, the method further includes performing a measurement on a non-zero power channel state reference signal and transmitting a second measurement report including the measurement, the second measurement report being separate from the first measurement report.

In some other embodiments, the method further includes performing another measurement on a non-zero power channel state reference signal and IpN on a channel state reference signal interference measurement resource.

In some embodiments, the first channel is a physical downlink shared channel.

According to another aspect, a wireless device (WD) configured to communicate with a network node is described. The WD is configured to receive a first configuration for an interference plus noise (IpN) measurement associated with a first channel, receive a data transmission from the network node on the first channel, and transmit a first measurement report to the network node. The first measurement report is based on the first configuration and the data transmission from the network node on the first channel. Further, the first measurement report includes the IpN measurement associated with the first channel.

In some embodiments, the first configuration includes an interference measurement resource (IMR) for reception of the first channel.

In some other embodiments, the WD is further configured to perform the IpN measurement on the IMR.

In some embodiments, one or both of the IMR configures residual demodulation reference signal (DMRS), and the WD is further configured to when the WD has performed a channel estimation on the DMRS associated with the first channel, estimate the IpN on one or more DMRS resources.

In some other embodiments, the IpN measurement is a power measurement of received power in one or more empty resource elements in a resource allocation of the first channel.

In some embodiments, the received power is normalized with respect to another measurement that reflects a desired channel.

In some other embodiments, the WD is further configured to one or more of: (A) determine the first measurement report based on the first configuration and the data transmission from the network node on the first channel; (B) transmit the IpN measurement to the network node in an uplink report; (C) transmit the IpN measurement to the network node as uplink control information in one or both of a physical uplink control channel and a physical uplink shared channel; and (D) transmit the IpN measurement together with acknowledgement information of the first channel.

In some embodiments, the IpN measurement corresponds to an entire bandwidth of the first channel or a plurality of bandwidth parts of the first channel.

In some other embodiments, the WD is further configured to receive a second configuration of channel state information measurement and reporting and transmit a CSI report based on the second configuration.

In some embodiments, the WD is further configured to perform a measurement on a non-zero power channel state reference signal and transmit a second measurement report including the measurement, the second measurement report being separate from the first measurement report.

In some other embodiments, the WD is further configured to perform another measurement on a non-zero power channel state reference signal and IpN on a channel state reference signal interference measurement resource.

In some embodiments, the first channel is a physical downlink shared channel.

According to one aspect, a method in a network node configured to communicate with a wireless device (WD) is described. The method includes transmitting a first configuration to the WD, where the first configuration is for an interference plus noise (IpN) measurement associated with a first channel and based on one or more parameters. The IpN measurement is to be performed by the WD. The method further includes transmitting a data transmission to the WD on the first channel and receiving a first measurement report from the WD. The first measurement report includes the IpN measurement associated with the first channel.

In some embodiments, the first configuration includes an interference measurement resource (IMR) for reception of the first channel.

In some other embodiments, the IpN measurement is performed on the IMR.

In some embodiments, one or both of the IMR configures residual demodulation reference signal (DMRS), and when the WD has performed a channel estimation on the DMRS associated with the first channel, the IpN is estimated on one or more DMRS resources.

In some other embodiments, the IpN measurement is a power measurement of received power in one or more empty resource elements in a resource allocation of the first channel.

In some embodiments, the received power is normalized with respect to another measurement that reflects a desired channel.

In some other embodiments, the method further includes one or more of: (A) determining the first configuration based on the one or more parameters; (B) receiving the IpN measurement from the WD in an uplink report; (C) receiving the IpN measurement from the WD as uplink control information in one or both of a physical uplink control channel and a physical uplink shared channel; and (D) receiving the IpN measurement together with acknowledgement information of the first channel.

In some embodiments, the IpN measurement corresponds to an entire bandwidth of the first channel or a plurality of bandwidth parts of the first channel.

In some other embodiments, the method further includes transmitting a second configuration of channel state information measurement and reporting and receiving a CSI report based on the second configuration.

In some embodiments, the method further includes receiving a second measurement report including a measurement performed on a non-zero power channel state reference signal, where the second measurement report is separate from the first measurement report.

In some other embodiments, one or both of the first measurement report is based on the first configuration and the data transmission to the WD on the first channel and the first channel is a physical downlink shared channel.

According to another aspect, a network node configured to communicate with a wireless device (WD) is described. The network node is configured to transmit a first configuration to the WD, where the first configuration being for an interference plus noise (IpN) measurement associated with a first channel and based on one or more parameters, and the IpN measurement to be performed by the WD. The network node is further configured to transmit a data transmission to the WD on the first channel and receive a first measurement report from the WD. The first measurement report includes the IpN measurement associated with the first channel.

In some embodiments, the first configuration includes an interference measurement resource, IMR, for reception of the first channel.

In some other embodiments, the IpN measurement is performed on the IMR.

In some embodiments, one or both of the IMR configures residual demodulation reference signal (DMRS), and when the WD has performed a channel estimation on the DMRS associated with the first channel, the IpN is estimated on one or more DMRS resources.

In some other embodiments, the IpN measurement is a power measurement of received power in one or more empty resource elements in a resource allocation of the first channel.

In some embodiments, the received power is normalized with respect to another measurement that reflects a desired channel.

In some other embodiments, the network node is further configured to one or more of: (A) determine the first configuration based on the one or more parameters; (B) receive the IpN measurement from the WD in an uplink report; (C) receive the IpN measurement from the WD as uplink control information in one or both of a physical uplink control channel and a physical uplink shared channel; and (D) receive the IpN measurement together with acknowledgement information of the first channel.

In some embodiments, the IpN measurement corresponds to an entire bandwidth of the first channel or a plurality of bandwidth parts of the first channel.

In some other embodiments, the network node is further configured to transmit a second configuration of channel state information measurement and reporting and receive a CSI report based on the second configuration.

In some embodiments, the network node is further configured to receive a second measurement report including a measurement performed on a non-zero power channel state reference signal, where the second measurement report is separate from the first measurement report.

In some other embodiments, one or both of the first measurement report is based on the first configuration and the data transmission to the WD on the first channel and the first channel is a physical downlink shared channel.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of a wireless communication system resource grid illustrating an example of a NZP CSI-RS resource configuration;

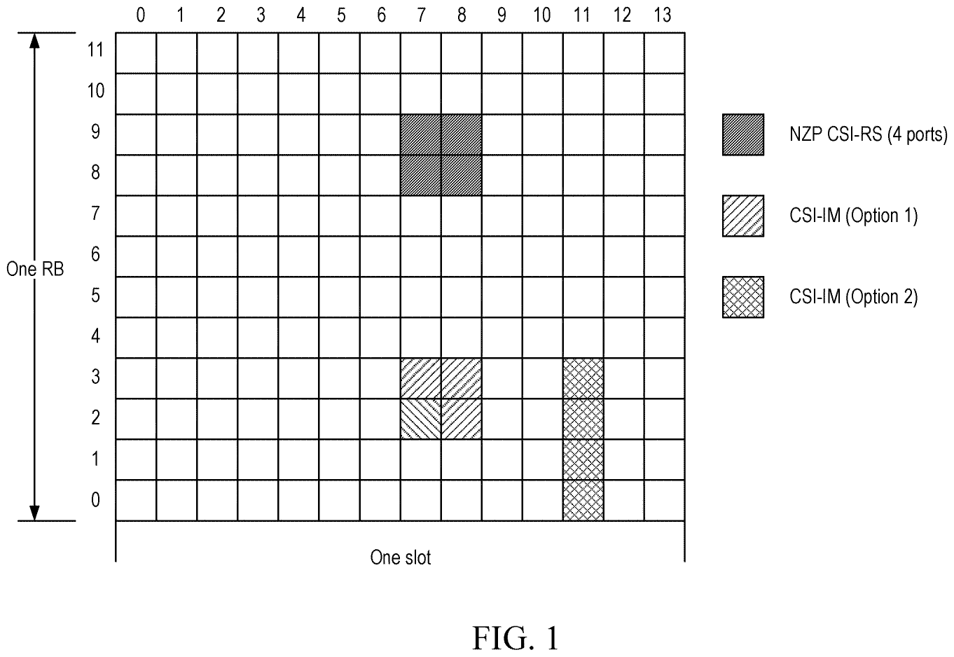

FIG. 2 is a schematic diagram of an example network architecture illustrating a communication system according to principles disclosed herein;

FIG. 3 is a block diagram of a network node in communication with a wireless device over a wireless connection according to some embodiments of the present disclosure;

FIG. 4 is a flowchart of an example process in a network node for efficient IpN reporting, according to some embodiments of the present disclosure;

FIG. 5 is a flowchart of an example process in a wireless device for efficient IpN reporting, according to some embodiments of the present disclosure;

FIG. 6 is a flowchart of another example process in a network node according to some embodiments of the present disclosure;

FIG. 7 is a flowchart of another example process in a wireless device according to some embodiments of the present disclosure;

FIG. 8 is a flowchart of another example process in a wireless device according to some embodiments of the present disclosure;

FIG. 9 is a flowchart of another example process in a network node according to some embodiments of the present disclosure; and

FIG. 10 shows an example process in a wireless communication system for efficient IpN reporting, according to some embodiments of the present disclosure.

### DETAILED DESCRIPTION

Before describing in detail exemplary embodiments, it is noted that the embodiments reside primarily in combinations of apparatus components and processing steps related to IpN reporting in a wireless communication network. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate, and modifications and variations are possible of achieving the electrical and data communication.

In some embodiments described herein, the term “coupled,” “connected,” and the like, may be used herein to indicate a connection, although not necessarily directly, and may include wired and/or wireless connections.

The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

In some embodiments, the term parameter is used and may refer to a parameter associated with a network node and/or a WD. Further, the parameter may be used by the network node and/or WD to determine a configuration. The configuration may be a configuration for the WD to perform IpN measurements and reporting. The measurements may be associated with a channel such as a communication channel between the network node and the WD (e.g., PDSCH, etc.). Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

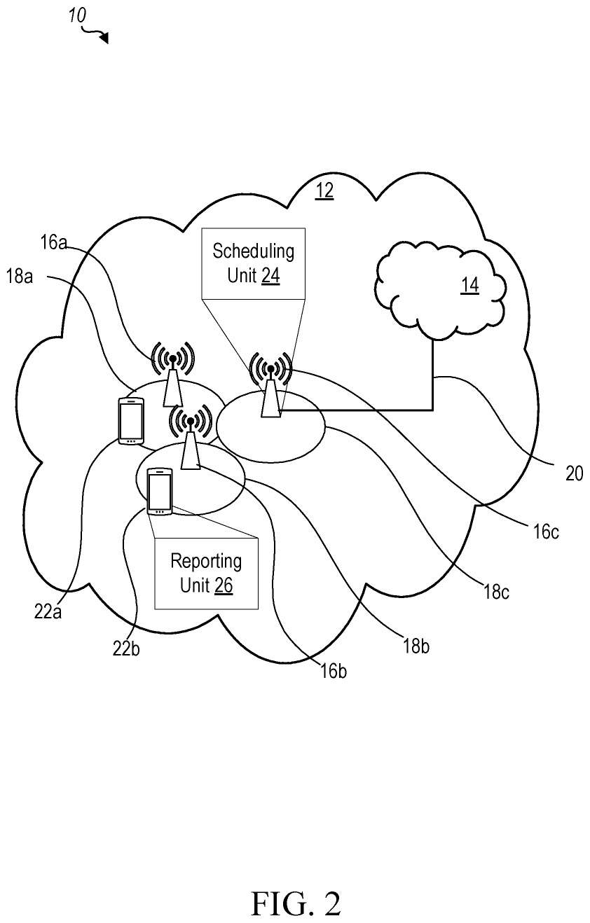

Some embodiments are directed to interference plus noise (IpN) measurement and reporting in a wireless communication network. Referring again to the drawing figures, in which like elements are referred to by like reference numerals, there is shown in FIG. 2 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

A network node 16 (e.g., eNB or gNB) is configured to include a scheduling unit 24 which is configured for determining/configuring one or more configurations for measurement reporting for wireless device(s) 22, to receive and/or compute one or more measurement reports from wireless devices 22, and to configure/schedule one or more uplink and/or downlink transmissions based thereon, as disclosed herein. A wireless device 22 is configured to include a reporting unit 26 which is configured for performing one or more measurements in accordance with a measurement and/or reporting configuration (e.g., received from network node 16), and for reporting the reports, measurements, and/or indications thereof to network node(s) 16, e.g., for use in scheduling and/or configuring transmissions.

Example implementations, in accordance with an embodiment, of the WD 22 and network node 16 discussed in the preceding paragraphs will now be described with reference to FIG. 2.

The communication system 10 includes a network node 16 provided in a communication system 10 and includes hardware 28 enabling it to communicate with the WD 22. The hardware 28 may include a radio interface 30 for setting up and maintaining at least a wireless connection 32 with a WD 22 located in a coverage area 18 served by the network node 16. The radio interface 30 may be formed as or may include, for example, one or more RF transmitters, one or more RF receivers, and/or one or more RF transceivers. The radio interface 30 includes an array of antennas 34 to radiate and receive signal(s) carrying electromagnetic waves.

In the embodiment shown, the hardware 28 of the network node 16 further includes processing circuitry 36. The processing circuitry 36 may include a processor 38 and a memory 40. In particular, in addition to or instead of a processor, such as a central processing unit, and memory, the processing circuitry 36 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 38 may be configured to access (e.g., write to and/or read from) the memory 40, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 42 stored internally in, for example, memory 40, or stored in external memory (e.g., database, storage array, network storage device, etc.) accessible by the network node 16 via an external connection. The software 42 may be executable by the processing circuitry 36. The processing circuitry 36 may be configured to control any of the methods and/or processes described herein and/or to cause such methods, and/or processes to be performed, e.g., by network node 16. Processor 38 corresponds to one or more processors 38 for performing network node 16 functions described herein. The memory 40 is configured to store data, programmatic software code and/or other information described herein. In some embodiments, the software 42 may include instructions that, when executed by the processor 38 and/or processing circuitry 36, causes the processor 38 and/or processing circuitry 36 to perform the processes described herein with respect to network node 16. For example, processing circuitry 36 of the network node 16 may include scheduling unit 24 which is configured for determining/configuring one or more configurations for measurement reporting for wireless device(s) 22, to receive and/or compute one or more measurement reports from wireless devices 22, and to configure/schedule one or more uplink and/or downlink transmissions based thereon, as disclosed herein.

The communication system 10 further includes the WD 22 already referred to. The WD 22 may have hardware 44 that may include a radio interface 46 configured to set up and maintain a wireless connection 32 with a network node 16 serving a coverage area 18 in which the WD 22 is currently located. The radio interface 46 may be formed as or may include, for example, one or more RF transmitters, one or more RF receivers, and/or one or more RF transceivers. The radio interface 46 includes an array of antennas 48 to radiate and receive signal(s) carrying electromagnetic waves.

The hardware 44 of the WD 22 further includes processing circuitry 50. The processing circuitry 50 may include a processor 52 and memory 54. In particular, in addition to or instead of a processor, such as a central processing unit, and memory, the processing circuitry 50 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 52 may be configured to access (e.g., write to and/or read from) memory 54, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 56, which is stored in, for example, memory 54 at the WD 22, or stored in external memory (e.g., database, storage array, network storage device, etc.) accessible by the WD 22. The software 56 may be executable by the processing circuitry 50. The software 56 may include a client application 58. The client application 58 may be operable to provide a service to a human or non-human user via the WD 22.

The processing circuitry 50 may be configured to control any of the methods and/or processes described herein and/or to cause such methods, and/or processes to be performed, e.g., by WD 22. The processor 52 corresponds to one or more processors 52 for performing WD 22 functions described herein. The WD 22 includes memory 54 that is configured to store data, programmatic software code and/or other information described herein. In some embodiments, the software 56 and/or the client application 58 may include instructions that, when executed by the processor 52 and/or processing circuitry 50, causes the processor 52 and/or processing circuitry 50 to perform the processes described herein with respect to WD 22. For example, the processing circuitry 50 of the wireless device 22 may include reporting unit 26 which is configured for performing one or more measurements in accordance with a measurement and/or reporting configuration (e.g., received from network node 16), and for reporting the reports, measurements, and/or indications thereof to network node(s) 16, e.g., for use in scheduling and/or configuring transmissions.

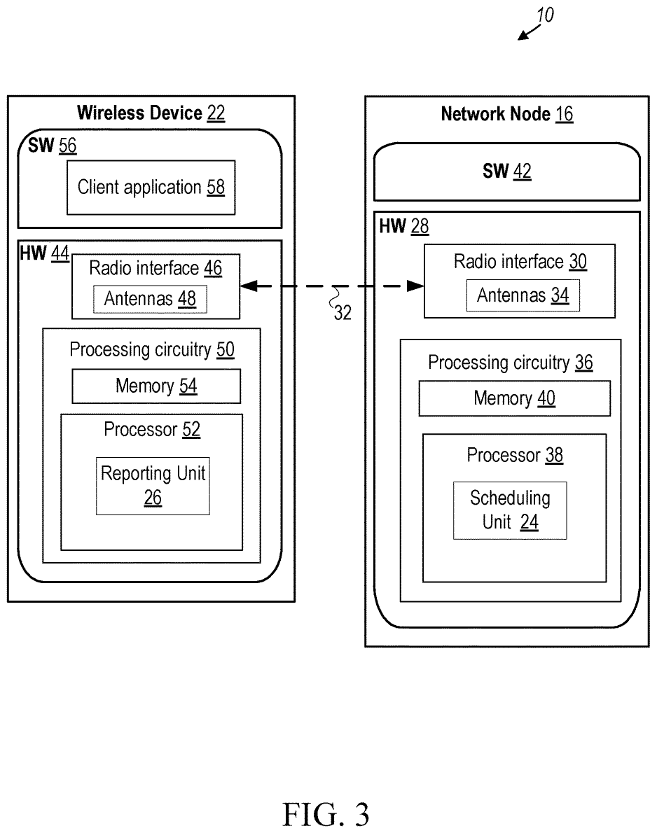

In some embodiments, the inner workings of the network node 16 and WD 22 may be as shown in FIG. 3 and independently, the surrounding network topology may be that of FIG. 2.

The wireless connection 32 between the WD 22 and the network node 16 is in accordance with the teachings of the embodiments described throughout this disclosure. More precisely, the teachings of some of these embodiments may improve the data rate, latency, and/or power consumption and thereby provide benefits such as reduced user waiting time, relaxed restriction on file size, better responsiveness, extended battery lifetime, etc. In some embodiments, a measurement procedure may be provided for the purpose of monitoring data rate, latency and other factors on which the one or more embodiments improve.

Although FIGS. 2 and 3 show various “units” such as scheduling unit 24 and reporting unit 26 as being within a respective processor, it is contemplated that these units may be implemented such that a portion of the unit is stored in a corresponding memory within the processing circuitry. In other words, the units may be implemented in hardware or in a combination of hardware and software within the processing circuitry.

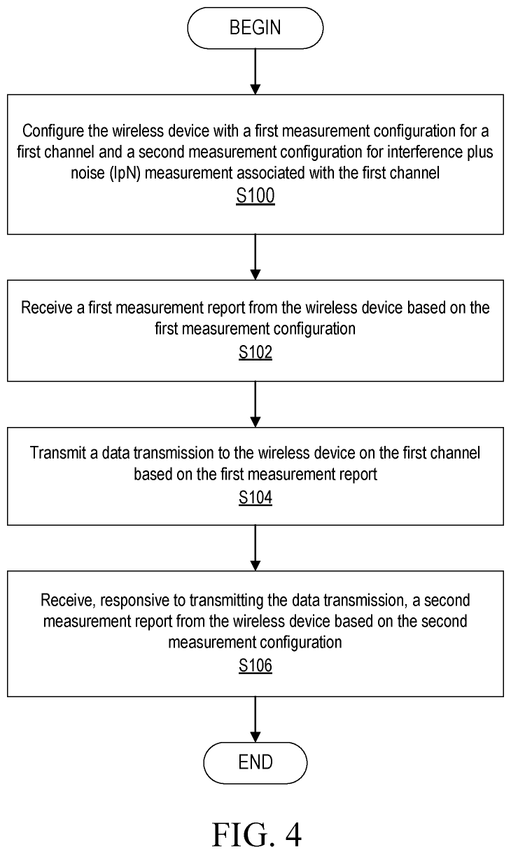

FIG. 4 is a flowchart of an example process in a network node 16 for efficient IpN reporting. One or more blocks described herein may be performed by one or more elements of network node 16 such as by one or more of processing circuitry 36 (including the scheduling unit 24), processor 38, and/or radio interface 30. Network node 16 such as via processing circuitry 36 and/or processor 38 and/or radio interface 30 is configured to configure (Block S100) (e.g., determine and/or receive configuration indication(s) and transmit the indication(s) to the wireless device 22) the wireless device with a first measurement configuration for a first channel and a second measurement configuration for interference plus noise (IpN) measurement associated with the first channel. The network node 16 is configured to receive (Block S102) a first measurement report from the wireless device 22 based on the first measurement configuration. Network node 16 is configured to transmit (Block S104) a data transmission to the wireless device 22 on the first channel based on the first measurement report. Network node 16 is configured to receive (Block S106), responsive to transmitting the data transmission, a second measurement report from the wireless device 22 based on the second measurement configuration.

In some embodiments, the network node 16 is further configured to schedule the data transmission to the wireless device 22 based on the first measurement report.

In some embodiments the first channel is a physical downlink shared channel (PDSCH).

In some embodiments, the second measurement configuration defines at least one of an interference measurement resource (IMR) associated with the first channel, and a demodulation reference signaling resource associated with the first channel.

In some embodiments, the first measurement report is reported with a first periodicity, and the second measurement report is reported aperiodically.

In some embodiments, the first measurement report indicates at least one of channel state information (CSI) using non-zero-power CSI reference signaling measurements, CSI using CSI-Interference Measurement (IM) resources, channel strength, and channel quality information (CQI).

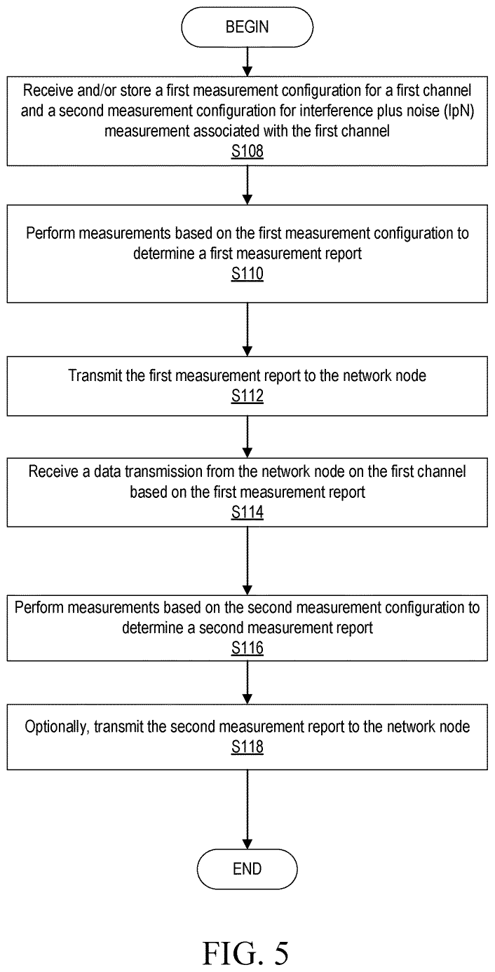

FIG. 5 is a flowchart of an example process in a wireless device 22 according to some embodiments of the present disclosure. One or more blocks described herein may be performed by one or more elements of wireless device 22 such as by one or more of processing circuitry 50 (including the reporting unit 26), processor 52, and/or radio interface 46. Wireless device 22 such as via processing circuitry 50 and/or processor 52 and/or radio interface 46 is configured to receive (e.g., from network node 16) and/or store (Block S108) a first measurement configuration for a first channel and a second measurement configuration for interference plus noise (IpN) measurement associated with the first channel. Wireless device 22 is configured to perform (Block S110) measurements based on the first measurement configuration to determine a first measurement report. Wireless device 22 is configured to transmit (Block S112) the first measurement report to the network node 16. Wireless device 22 is configured to receive (Block S114) a data transmission from the network node 16 on the first channel based on the first measurement report. Wireless device 22 is configured to perform (Block S116) measurements based on the second measurement configuration (e.g., which may define resources of the data transmission and/or first channel to be measured for IpN) to determine a second measurement report. Wireless device 22 is configured to, optionally, transmit (Block S118) the second measurement report to the network node.

In some embodiments, the data transmission is scheduled based on the first measurement report.

In some embodiments the first channel is a physical downlink shared channel (PDSCH).

In some embodiments, the second measurement configuration defines at least one of an interference measurement resource (IMR) associated with the first channel, and a demodulation reference signaling resource associated with the first channel.

In some embodiments, the first measurement report is reported with a first periodicity, and the second measurement report is reported aperiodically.

In some embodiments, the first measurement report indicates at least one of channel state information (CSI) using non-zero-power CSI reference signaling measurements, CSI using CSI-Interference Measurement (IM) resources, channel strength, and channel quality information (CQI).

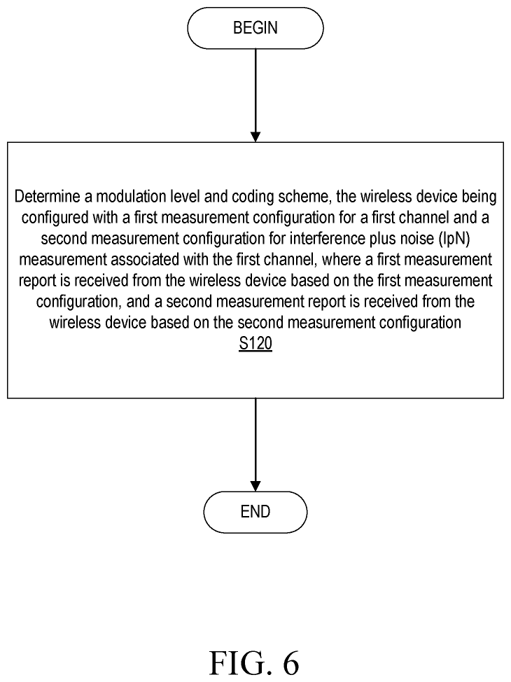

FIG. 6 is a flowchart of another example process in a network node 16 according to some embodiments of the present disclosure. One or more blocks described herein may be performed by one or more elements of network node 16 such as by one or more of processing circuitry 36 (including the scheduling unit 24), processor 38, and/or radio interface 30. Network node 16 such as via processing circuitry 36 and/or processor 38 and/or radio interface 30 is configured to determine (Block S120) a modulation level and coding scheme, the wireless device 22 being configured with a first measurement configuration for a first channel and a second measurement configuration for interference plus noise (IpN) measurement associated with the first channel, where a first measurement report is received from the wireless device 22 based on the first measurement configuration, and a second measurement report is received from the wireless device 22 based on the second measurement configuration.

In some embodiments, the second measurement report is responsive to a data transmission to the wireless device 22 on the first channel based on the first measurement report.

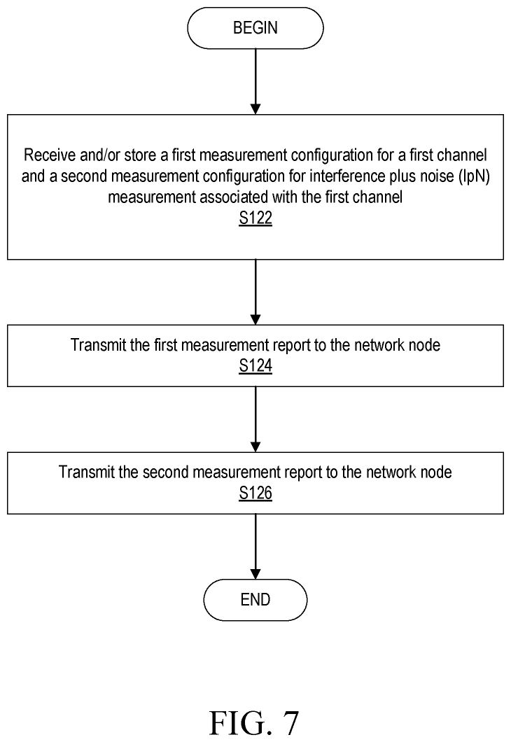

FIG. 7 is a flowchart of another example process in a wireless device 22 according to some embodiments of the present disclosure. One or more blocks described herein may be performed by one or more elements of wireless device 22 such as by one or more of processing circuitry 50 (including the reporting unit 26), processor 52, and/or radio interface 46. Wireless device 22 such as via processing circuitry 50 and/or processor 52 and/or radio interface 46 is configured to receive (Block S122) and/or store a first measurement configuration for a first channel and a second measurement configuration for interference plus noise (IpN) measurement associated with the first channel. Wireless device 22 is configured to transmit (Block S124) the first measurement report to the network node 16. Wireless device 22 is configured to transmit (Block S126) the second measurement report to the network node 16.

In some embodiments, the second measurement report is based on a received data transmission from the network node 16 on the first channel based on the first measurement report.

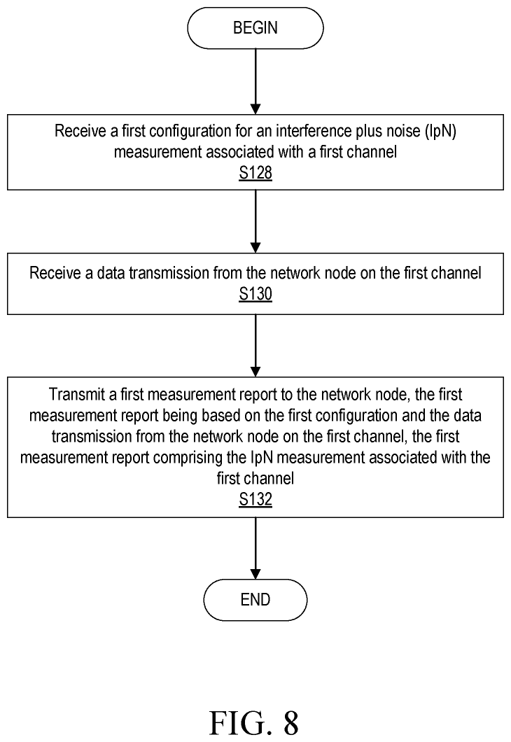

FIG. 8 is a flowchart of another example process in a wireless device 22 according to some embodiments of the present disclosure. One or more blocks described herein may be performed by one or more elements of wireless device 22 such as by one or more of processing circuitry 50 (including the reporting unit 26), processor 52, and/or radio interface 46. Wireless device 22 such as via processing circuitry 50 and/or processor 52 and/or radio interface 46 is configured to receive (Block S128) a first configuration for an interference plus noise (IpN) measurement associated with a first channel, receive (Block S130) a data transmission from the network node 16 on the first channel, and transmit (Block S132) a first measurement report to the network node 16. The first measurement report is based on the first configuration and the data transmission from the network node 16 on the first channel. Further, the first measurement report includes the IpN measurement associated with the first channel.

In some embodiments, the first configuration includes an interference measurement resource (IMR) for reception of the first channel.

In some other embodiments, the method further includes performing the IpN measurement on the IMR.

In some embodiments, one or both of the IMR configures residual demodulation reference signal (DMRS), and the method further includes when the WD 22 has performed a channel estimation on the DMRS associated with the first channel, estimating the IpN on one or more DMRS resources.

In some other embodiments, the IpN measurement is a power measurement of received power in one or more empty resource elements in a resource allocation of the first channel.

In some embodiments, the received power is normalized with respect to another measurement that reflects a desired channel.

In some other embodiments, the method further includes one or more of: (A) determining the first measurement report based on the first configuration and the data transmission from the network node 16 on the first channel; (B) transmitting the IpN measurement to the network node 16 in an uplink report; (C) transmitting the IpN measurement to the network node 16 as uplink control information in one or both of a physical uplink control channel and a physical uplink shared channel; and (D) transmitting the IpN measurement together with acknowledgement information of the first channel.

In some embodiments, the IpN measurement corresponds to an entire bandwidth of the first channel or a plurality of bandwidth parts of the first channel.

In some other embodiments, the method further includes receiving a second configuration of channel state information measurement and reporting and transmitting a channel state information (CSI) report based on the second configuration.

In some embodiments, the method further includes performing a measurement on a non-zero power channel state reference signal and transmitting a second measurement report including the measurement, the second measurement report being separate from the first measurement report.

In some other embodiments, the method further includes performing another measurement on a non-zero power channel state reference signal and IpN on a channel state reference signal interference measurement resource.

In some embodiments, the first channel is a physical downlink shared channel.

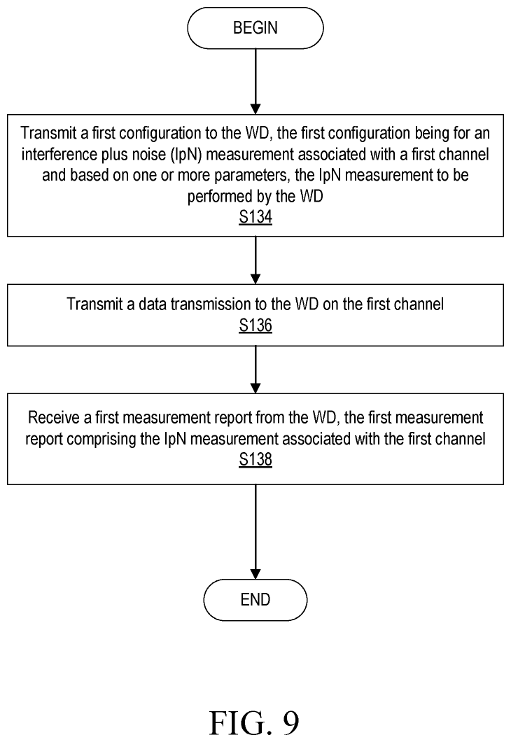

FIG. 9 is a flowchart of another example process in a network node 16 according to some embodiments of the present disclosure. One or more blocks described herein may be performed by one or more elements of network node 16 such as by one or more of processing circuitry 36 (including the scheduling unit 24), processor 38, and/or radio interface 30. Network node 16 such as via processing circuitry 36 and/or processor 38 and/or radio interface 30 is configured to transmit (Block S134) a first configuration to the WD 22, where the first configuration is for an interference plus noise (IpN) measurement associated with a first channel and based on one or more parameters. The IpN measurement is to be performed by the WD 22. The network node 16 is further configured to transmit (Block S136) a data transmission to the WD 22 on the first channel and receive (Block S138) a first measurement report from the WD 22. The first measurement report includes the IpN measurement associated with the first channel.

In some embodiments, the first configuration includes an interference measurement resource (IMR) for reception of the first channel.

In some other embodiments, the IpN measurement is performed on the IMR.

In some embodiments, one or both of the IMR configures residual demodulation reference signal (DMRS), and when the WD 22 has performed a channel estimation on the DMRS associated with the first channel, the IpN is estimated on one or more DMRS resources.

In some other embodiments, the IpN measurement is a power measurement of received power in one or more empty resource elements in a resource allocation of the first channel.

In some embodiments, the received power is normalized with respect to another measurement that reflects a desired channel.

In some other embodiments, the method further includes one or more of: (A) determining the first configuration based on the one or more parameters; (B) receiving the IpN measurement from the WD 22 in an uplink report; (C) receiving the IpN measurement from the WD 22 as uplink control information in one or both of a physical uplink control channel and a physical uplink shared channel; and (D) receiving the IpN measurement together with acknowledgement information of the first channel.

In some embodiments, the IpN measurement corresponds to an entire bandwidth of the first channel or a plurality of bandwidth parts of the first channel.

In some other embodiments, the method further includes transmitting a second configuration of channel state information measurement and reporting and receiving a CSI report based on the second configuration.

In some embodiments, the method further includes receiving a second measurement report including a measurement performed on a non-zero power channel state reference signal, where the second measurement report is separate from the first measurement report.

In some other embodiments, one or both of the first measurement report is based on the first configuration and the data transmission to the WD 22 on the first channel and the first channel is a physical downlink shared channel.

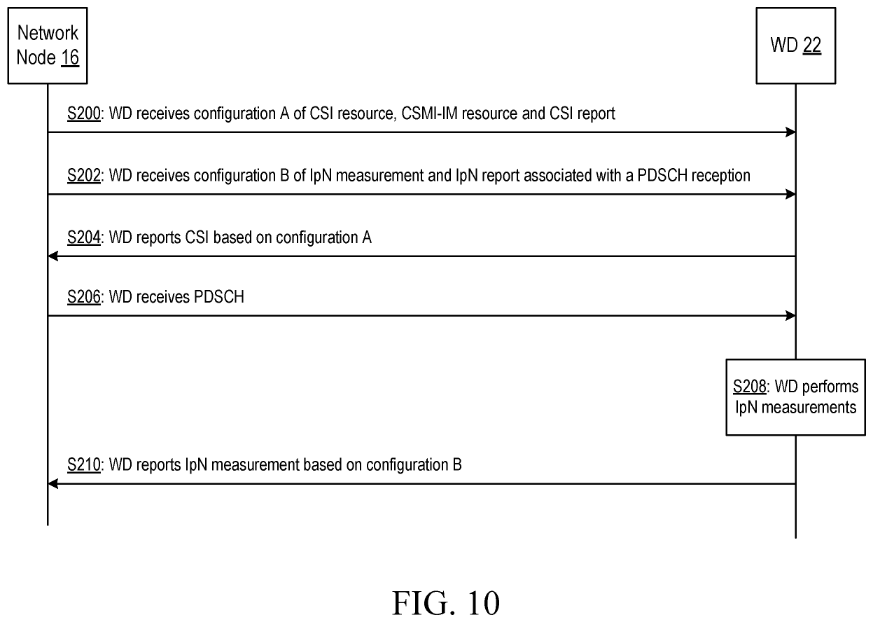

In some embodiments, the first configuration refers to configuration B (shown in FIG. 10, below), the data transmission refers to data transmitted on PDSCH (shown in FIG. 10), and the first measurement report refers to the reported IpN measurement (shown in FIG. 10).

Having described the general process flow of arrangements of the disclosure and having provided examples of hardware and software arrangements for implementing the processes and functions of the disclosure, the sections below provide details and examples of arrangements for IpN reporting.

For example, in some embodiments, the network node 16 configures the wireless device 22 with an interference measurement resource, where the interference measurement using the configured resource is performed in association with a PDSCH reception.

### Introduction of PDSCH-IMR for IpN

In some embodiments, the measured and estimated interference using the same resource is used for both reporting of an interference plus noise (IpN) metric or IpN measurement from the wireless device 22 to the network node 16, and for channel estimation of the demodulation of the PDSCH reception. IpN may refer to one or more values or metrics or measurements, which may indicate interference and/or noise. The interference and/or noise may be associated with a channel of communication, e.g., between WD 22 and network node 16. In some embodiments, interference and/or noise may be a vector or indicated using a vector representation. IpN may be associated with SINR or any other parameter. In some embodiments, IpN is associated with a resource (e.g., of the channel of communication). In some other embodiments, IpN is a metric, measurement, or value that indicates the interference and/or noise and/or power associated with interference and/or noise corresponding to signalling between the network node 16 and WD 22 (and/or any other component of system 10).

In an embodiment, an interference measurement resource (IMR) is introduced for the PDSCH reception, which may be referred to as PDSCH-IMR. The PDSCH-IMR can be used by the wireless device 22 to measure the IpN. The IpN may be used by the wireless device 22 for PDSCH reception, for example to adjust the DM-RS channel estimation algorithm or in advanced receiver algorithms such as interference rejection receiver utilizing multiple receive antenna elements.

In existing networks and specifications, it is not specified how the wireless device 22 may measure IpN when receiving the PDSCH or PDCCH. This measurement and the resource used for such measurement for channel estimation and demodulation may vary for different wireless device 22 implementations. An observed problem in networks is that such unspecified measurement resource can lead to performance degradations in the network (e.g., depending on which resource the wireless device 22 implementation has chosen).

In some embodiments, a dedicated IpN resource may be defined in association with a PDSCH. For example, the PDSCH configuration from a network node 16 to wireless device 22 using RRC signalling can include an IMR, which may be referred to as PDSCH-IMR. This could be one or more reserved resource elements within the resource allocation scheduled for the PDSCH (i.e., the scheduled bandwidth and time duration). The location of these PDSCH is given by the specifications and possible also network node 16 to wireless device 22 configuration. In some embodiments, the network node 16 and/or wireless device 22 may use a configuration of a zero power (ZP) CSI-RS as PDSCH-IMR.

In some embodiments, the IpN measurement the wireless device 22 may perform on these IMR (e.g., a power measurement), may be quantized and reported in the IpN report as discussed herein. Hence, in some embodiments, the IMR may be used at least for two purposes: both PDSCH demodulation and a measurement for the IpN reporting.

### Normalization of IpN

In some embodiments, the IpN may be a power measurement of received power in “empty” resource elements in the PDCSH resource allocation. In some embodiments, the power may be normalized (e.g., the scalar is divided by another scalar) with respect to another measurement that reflects the desired channel. This normalization factor may be defined as the power received on one or more of the PDSCH DMRS. For example, a scalar may be defined as average power (e.g., in linear scale) of all layers PDSCH DMRS. In some other embodiments, the normalization factor may be obtained from a measurement on the NZP CSI-RS, for example, the average power of a most recent occasion of a NZP CSI-RS that is configured to be quasi co-located (QCL) with the PDSCH DMRS. For example, this may be the tracking RS (TRS) in the transmission configuration indicator (TCI) state that is currently associated with the PDSCH DMRS.

### Using DMRS for Estimate PDSCH-IMR for IpN

In some embodiments, the PDSCH-IMR may be configured using the residual DMRS. Hence, when the wireless device 22 has performed the channel estimation on the DMRS associated with the PDSCH, then WD 22 may estimate the IpN on these DMRS resources by removing the known part (i.e., the channel). In this case, the PDSCH-IMR may be the same as the PDSCH-DMRS. In some embodiments, the IpN estimate may not be available to be used to enhance the channel estimation algorithm, in which case, a recursive channel estimation algorithm may be used, e.g., where the IpN estimate is obtained as a residual after the first iteration and the IpN is then used to improve the channel estimate in a second iteration.

### Reporting of IpN

In some embodiments, the estimated IpN (e.g., IpN measurement, metric, etc.) is transmitted by WD 22 to the network node 16 in a separate UL report. For example, the estimated IpN could be sent as Uplink Control Information (UCI), e.g., in PUCCH or PUSCH signalling. Hence, the IpN report may be configured to be independently reported compared to the report that contains information that relates to the desired channel, i.e., to measurements on the NZP CSI-RS or SSB from the serving network node. This decoupling takes advantage of that the channel a wireless device 22 observes typically varies slower than the observed interference, and thus the decoupling in some embodiments allows different reporting periodicity for these metrics. Also, the channel part can be a periodic report and the interference (IpN) part can be an aperiodic report.

In some embodiments, the IpN may be reported together with the hybrid automatic repeat request acknowledgement (HARQ-ACK) information of the PDSCH transmission with which the IMR is associated. Since PDSCH scheduling typically may be “aperiodic” and on demand, the IpN report may also have an aperiodic and on demand characteristic. In some embodiments, the IpN measurement may be triggered or configured by the network node 16 to be reported over a Medium Access Control (MAC), using, for example, a MAC Control Element (MAC CE).

### Granularity and Extensions of IpN

In some embodiments, one IpN value is reported by the WD 22 for the entire PDSCH bandwidth, i.e., wideband IpN reporting. In another embodiment, the PDSCH bandwidth is split in multiple bandwidth parts, and one IpN value is reported for each bandwidth part of the PDSCH bandwidth and/or on a per-subband basis, i.e., subband IpN reporting. One or more IpN values may correspond to one or more PDSCH bandwidth part(s) or subbands. In some embodiments, one IpN value is reported for at least some part(s) of the PDSCH bandwidth. For example, one or more bandwidth parts or subbands may have multiple corresponding IpN values, one corresponding IpN value, or no corresponding IpN value. In a third alternative, a PDSCH-IMR is introduced/reported/determined for each MIMO layer of the PDSCH and reported.

In another embodiment, if the wireless device 22 may receive multiple PDSCH transmissions simultaneously, e.g., from multiple transmission points (TRP), for example, as in accordance with multi-TRP reception (e.g., defined by 3GPP Release 16 and/or other versions of NR standards), then the same overlapping PDSCH-IMR may be configured (e.g., explicitly signalled) and/or assumed (e.g., implied and/or implicitly signalled) for both PDSCHs, e.g., in order to not capture the interference from “the other” PDSCH. Hence, in some embodiments, the intention is to capture IpN information from other ongoing transmissions in the network, not from the one(s) the wireless device 22 is currently receiving.

### Combinations of IpN Report and Legacy CSI Reports

In some embodiments, the legacy reporting of CQI is replaced by a new type of report where the channel strength (e.g., based on NZP CSI-RS) is reported. In a network node 16 aspect of the present disclosure, the network node 16 combines the IpN report with the report of the channel strength to estimate the signal to noise and interference ratio, which is subsequently used by the network node 16 to determine a modulation level and coding scheme (MCS) for the subsequent transmissions to the wireless device 22. Note that in some embodiments, the interval between the channel strength reports may be larger than the interval between the IpN reports.

In some embodiments, the IpN reports from the wireless device 22 may only be acquired at the network node 16 side when there is an ongoing burst of PDSCH transmissions to the wireless device 22. If there are no PDSCH transmissions, then the network node 16 may rely on the legacy CSI reporting (e.g., based on NZP CSI-RS for channel and interference measurement resource (IMR) for IpN measurements). For example, when there is no PDSCH to transmit, this legacy reporting may provide an acceptable level of performance (and/or may be used for link adaptation of the first PDSCH transmission).

When a packet of data is to be transmitted to the wireless device 22, a burst of PDSCHs may be transmitted to the wireless device 22 and the network node 16 may according to some embodiments obtain a very frequent update of the IpN from the IpN reports associated with each PDSCH reception. Thereby the network node 16 may adjust the link adaptation with increased accuracy, e.g., by considering the stream of IpN reports. Hence, as another network node 16 implementation aspect of the invention, the network node 16 node may combine the recent legacy CSI (i.e., CQI) report with the more frequent and/or recent IpN reports. Detailed methods for performing such combining may be out of the scope of this disclosure. In some embodiments, the network node 16 node may use multiple IpN reports to compute an updated CQI, for example, a weighted average, where the most recent IpN report has more weight, and/or less recent IpN reports have correspondingly lower weights.

The following examples according to some embodiments of the present disclosure include combining existing/legacy reporting with IpN reports as described herein:
Legacy operation: wireless device 22 measures channel(s) on NZP CSI-RS and IpN on CSI-IM (i.e., the IMR). The wireless device 22 computes CQI and reports measurements/CQI to the network node 16, e.g., via uplink control and/or data signalling for measurements/CQI/channel information reporting.
Example 1 according to some embodiments of the present disclosure: wireless device 22 measures channel(s) on NZP CSI-RS and IpN on PDSCH-IMR respectively (e.g., at the same time and/or at two different instances). The wireless device 22 reports these two measurement(s) (e.g., by reporting the measurement values, reporting index values corresponding to the measurement values, etc.) to the network node 16, e.g., in two separate reports (and/or messages, indications, etc.). The network node 16 utilizes the two reports (channel(s) on NZP CSI-RS and IpN on PDSCH-IMR) to determine a modulation level and coding scheme (MCS) for the subsequent transmission(s) to the wireless device 22.
Example 2 according to some embodiments of the present disclosure: the wireless device 22 measures the channel(s) on NZP CSI-RS and IpN on CSI-IM (i.e., the IMR). The wireless device 22 computes CQI and reports it to the network node 16. In addition, the wireless device 22 measures IpN on PDSCH-IMR, e.g., when it received a PDSCH. The wireless device 22 reports this PDSCH-IpN, e.g., together with HARQ-ACK for the PDSCH.

In some embodiments, the interference reports based on PDSCH-IpN may be generated/signalled/reported with a higher frequency if the PDSCH is scheduled to the wireless device 22 with a higher frequency.

In some embodiments, the NZP CSI-RS and PDSCH-IMR typically may not be received together. For example, the NZP CSI-RS (and the legacy CSI-IM) for the CSI report may be received every 10 ms, while the PDSCH-IMR may be received every slot (0.5 ms), e.g., if the wireless device 22 is scheduled frequently. Hence, there may be a decoupling of channel and interference measurements which matches the observation that the channel varies slowly compared to the interference.

In one embodiment, the DCI that scheduled the PDSCH to the wireless device 22 may include an indication as to whether the IpN measurement should be executed or not, e.g., for one or more transmissions, time periods, time slots, etc. If not, the behaviour would revert to a legacy operation.

FIG. 8 shows a sequence diagram of an example method in accordance with embodiments of the present disclosure, where the wireless device 22 receives (Step S200), from network node 16, a legacy configuration A of CSI measurement and reporting (not necessarily in the same configuration message) and receives (Step S202) a configuration B of IpN measurement and report (not necessarily in the same message). The wireless device 22 reports (Step S204) legacy CSI using NZP CSI-RS and CSI-IM measurements, and/or which measurement resources can be periodic or aperiodic, to network node 16. The wireless device 22 may be scheduled and/or configured to receive (Step S206) a PDSCH, e.g., from network node 16. The wireless device 22 performs (Step S208) IpN measurement, e.g., on the PDSCH-IMR, and reports (Step S210) the IpN measurement to the network node 16, e.g., based on configuration B. In some embodiments, the IpN report may be appended to the HARQ-ACK report from the wireless device 22 or appended to a PUSCH transmission from the wireless device 22.

The following is a nonlimiting list of example embodiments.

### Embodiment A1

A network node configured to communicate with a wireless device, the network node configured to, and/or comprising a radio interface and/or comprising processing circuitry configured to:
configure the wireless device with a first measurement configuration for a first channel and a second measurement configuration for interference plus noise (IpN) measurement associated with the first channel;
receive a first measurement report from the wireless device based on the first measurement configuration;
transmit a data transmission to the wireless device on the first channel based on the first measurement report; and
receive, responsive to transmitting the data transmission, a second measurement report from the wireless device based on the second measurement configuration.

### Embodiment A2

The network node of Embodiment A1, wherein the network node is further configured to schedule the data transmission to the wireless device based on the first measurement report.

### Embodiment A3

The network node of any of Embodiments A1 and A2, wherein the first channel is a physical downlink shared channel (PDSCH).

### Embodiment A4

The network node of any of Embodiments A1-A3, wherein the second measurement configuration defines at least one of:
an interference measurement resource (IMR) associated with the first channel; and
a demodulation reference signaling resource associated with the first channel.

### Embodiment A5

The network node of any of Embodiments A1-A4, wherein the first measurement report is reported with a first periodicity, and the second measurement report being reported aperiodically.

### Embodiment A6

The network node of any of Embodiments A1-A5, wherein the first measurement report indicates at least one of:
channel state information (CSI) using non-zero-power CSI reference signaling measurements;
CSI using CSI-Interference Measurement (IM) resources;
channel strength; and
channel quality information (CQI).

### Embodiment B1

A method implemented in a network node that is configured to communicate with a wireless device, the method comprising:
configuring the wireless device with a first measurement configuration for a first channel and a second measurement configuration for interference plus noise (IpN) measurement associated with the first channel;
receiving a first measurement report from the wireless device based on the first measurement configuration;
transmitting a data transmission to the wireless device on the first channel based on the first measurement report; and
receiving, responsive to transmitting the data transmission, a second measurement report from the wireless device based on the second measurement configuration.

### Embodiment B2

The method of Embodiment B1, further comprising scheduling the data transmission to the wireless device based on the first measurement report.

### Embodiment B3

The method of any of Embodiments B1 and B2, wherein the first channel is a physical downlink shared channel (PDSCH).

### Embodiment B4

The method of any of Embodiments B1-B3, wherein the second measurement configuration defines at least one of:
an interference measurement resource (IMR) associated with the first channel; and
a demodulation reference signaling resource associated with the first channel.

### Embodiment B5

The method of any of Embodiments B1-B4, wherein the first measurement report is reported with a first periodicity, and the second measurement report being reported aperiodically.

### Embodiment B6

The method of any of Embodiments B1-B5, wherein the first measurement report indicates at least one of:
channel state information (CSI) using non-zero-power CSI reference signaling measurements;
CSI using CSI-Interference Measurement (IM) resources;
channel strength; and
channel quality information (CQI).

### Embodiment C1

A wireless device (WD) configured to communicate with a network node, the WD configured to, and/or comprising a radio interface and/or processing circuitry configured to:
receive and/or store a first measurement configuration for a first channel and a second measurement configuration for interference plus noise (IpN) measurement associated with the first channel;
perform measurements based on the first measurement configuration to determine a first measurement report;
transmit the first measurement report to the network node;
receive a data transmission from the network node on the first channel based on the first measurement report;
perform measurements based on the second measurement configuration to determine a second measurement report; and
optionally, transmit the second measurement report to the network node.

### Embodiment C2

The wireless device of Embodiment C1, wherein the data transmission is scheduled based on the first measurement report.

### Embodiment C3

The wireless device of any of Embodiments C1 and C2, wherein the first channel is a physical downlink shared channel (PDSCH).

### Embodiment C4

The wireless device of any of Embodiments C₁-C₃, wherein the second measurement configuration defines at least one of
an interference measurement resource (IMR) associated with the first channel; and
a demodulation reference signaling resource associated with the first channel

### Embodiment C5

The wireless device of any of Embodiments C₁-C₄, wherein the first measurement report is reported with a first periodicity, and the second measurement report being reported aperiodically.

### Embodiment C6

The wireless device of any of Embodiments C₁-C₅, wherein the first measurement report indicates at least one of:
channel state information (CSI) using non-zero-power CSI reference signaling measurements;
CSI using CSI-Interference Measurement (IM) resources;
channel strength; and
channel quality information (CQI).

### Embodiment D1

A method implemented in a wireless device (WD) that is configured to communicate with a network node, the method comprising:
receiving and/or storing a first measurement configuration for a first channel and a second measurement configuration for interference plus noise (IpN) measurement associated with the first channel;
performing measurements based on the first measurement configuration to determine a first measurement report;
transmitting the first measurement report to the network node;
receiving a data transmission from the network node on the first channel based on the first measurement report;
performing measurements based on the second measurement configuration to determine a second measurement report; and
optionally, transmitting the second measurement report to the network node.

### Embodiment D2

The method of Embodiment D1, wherein the data transmission is scheduled based on the first measurement report.

### Embodiment D3

The method of any of Embodiments D1 and D2, wherein the first channel is a physical downlink shared channel (PDSCH).

### Embodiment D4

The method of any of Embodiments D1-D3, wherein the second measurement configuration defines at least one of:
an interference measurement resource (IMR) associated with the first channel; and
a demodulation reference signaling resource associated with the first channel.

### Embodiment D5

The method of any of Embodiments D1-D4, wherein the first measurement report is reported with a first periodicity, and the second measurement report being reported aperiodically.

### Embodiment D6

The method of any of Embodiments D1-D5, wherein the first measurement report indicates at least one of:
channel state information (CSI) using non-zero-power CSI reference signaling measurements;
CSI using CSI-Interference Measurement (IM) resources;
channel strength; and channel quality information (CQI).

### Embodiment E1

A network node configured to communicate with a wireless device, the network node configured to, and/or comprising a radio interface and/or comprising processing circuitry configured to:
determine a modulation level and coding scheme, the wireless device being configured with a first measurement configuration for a first channel and a second measurement configuration for interference plus noise (IpN) measurement associated with the first channel;
a first measurement report being received from the wireless device based on the first measurement configuration; and
a second measurement report being received from the wireless device based on the second measurement configuration.

### Embodiment E2

The network node of Embodiment E1, wherein the second measurement report is responsive to a data transmission to the wireless device on the first channel based on the first measurement report.

### Embodiment F1

A method implemented in a network node configured to communicate with a wireless device, the method comprising:
determining a modulation level and coding scheme, the wireless device being configured with a first measurement configuration for a first channel and a second measurement configuration for interference plus noise (IpN) measurement associated with the first channel;
a first measurement report being received from the wireless device based on the first measurement configuration; and
a second measurement report being received from the wireless device based on the second measurement configuration.

### Embodiment F2

The method of Embodiment F1, wherein the second measurement report is responsive to a data transmission to the wireless device on the first channel based on the first measurement report.

### Embodiment G1

A wireless device (WD) configured to communicate with a network node, the WD configured to, and/or comprising a radio interface and/or processing circuitry configured to:
receive and/or store a first measurement configuration for a first channel and a second measurement configuration for interference plus noise (IpN) measurement associated with the first channel;
transmit the first measurement report to the network node; and
transmit the second measurement report to the network node.

### Embodiment G2

The WD of Embodiment G1, wherein the second measurement report is based on a received data transmission from the network node on the first channel based on the first measurement report.

### Embodiment H1

A method implemented in a wireless device configured to communicate with a network node, the method comprising:
receiving and/or storing a first measurement configuration for a first channel and a second measurement configuration for interference plus noise (IpN) measurement associated with the first channel;
transmitting the first measurement report to the network node; and
transmitting the second measurement report to the network node.

### Embodiment H2

The method of Embodiment H1, wherein the second measurement report is based on a received data transmission from the network node on the first channel based on the first measurement report.

In some embodiments, the first measurement configuration refers to configuration A shown in FIG. 10, and the second measurement configuration refers to configuration B shown in FIG. 10. In some other embodiments, the first measurement report refers to the report of step S204 of FIG. 10. In some embodiments, the second measurement report refers to the report of step S208 of FIG. 10.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object-oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:
CQI Channel Quality Information
CSI Channel State Information
CSI-IM Channel state Information-Interference Measurement (Resource)
DCI Downlink Control Information
IMR Interference Measurement Resource
IpN Interference plus Noise
NW Network, e.g., a network node such as a gNB
NZP CSI-RS Non-zero Power Channel State Information Reference Signal
PDSCH Physical Downlink Shared data channel
QCL Quasi Co-location
TCI Transmission Configuration Indicator
UCI Uplink Control Information
UE User Equipment

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A method in a wireless device, WD, configured to communicate with a network node, the method comprising:
receiving a first configuration for an interference plus noise, IpN, measurement associated with a first channel;
receiving a data transmission from the network node on the first channel; and
transmitting a first measurement report to the network node, the first measurement report being based on the first configuration and the data transmission from the network node on the first channel, the first measurement report comprising the IpN measurement associated with the first channel.

2. The method of claim 1, wherein the first configuration includes an interference measurement resource, IMR, for reception of the first channel.

3. The method of claim 2, wherein the method further includes: performing the IpN measurement on the IMR.

4. The method of claim 2, wherein one or both of:
the IMR configures residual demodulation reference signal, DMRS; and
the method further includes when the WD has performed a channel estimation on the DMRS associated with the first channel, estimating the IpN on one or more DMRS resources.

5. The method of claim 1, wherein the IpN measurement is a power measurement of received power in one or more empty resource elements in a resource allocation of the first channel.

6. The method of claim 5, wherein the received power is normalized with respect to another measurement that reflects a desired channel.

7. The method of claim 1, wherein the method further includes one or more of:
determining the first measurement report based on the first configuration and the data transmission from the network node on the first channel;
transmitting the IpN measurement to the network node in an uplink report;
transmitting the IpN measurement to the network node as uplink control information in one or both of a physical uplink control channel and a physical uplink shared channel; and
transmitting the IpN measurement together with acknowledgement information of the first channel.

8. The method of claim 1, wherein the IpN measurement corresponds to an entire bandwidth of the first channel or a plurality of bandwidth parts of the first channel.

9. The method of claim 1, wherein the method further includes:
receiving a second configuration of channel state information measurement and reporting; and
transmitting a channel state information, CSI, report based on the second configuration.

10. The method of claim 1, wherein the method further includes:
performing a measurement on a non-zero power channel state reference signal; and
transmitting a second measurement report including the measurement, the second measurement report being separate from the first measurement report.

11. The method of claim 1, wherein the method further includes:
performing another measurement on a non-zero power channel state reference signal and IpN on a channel state reference signal interference measurement resource.

12. The method of claim 1, wherein the first channel is a physical downlink shared channel.

13. A wireless device, WD, configured to communicate with a network node, the WD being configured to:
receive a first configuration for an interference plus noise, IpN, measurement associated with a first channel;
receive a data transmission from the network node on the first channel; and
transmit a first measurement report to the network node, the first measurement report being based on the first configuration and the data transmission from the network node on the first channel, the first measurement report comprising the IpN measurement associated with the first channel.

14-24. (canceled)

25. A method in a network node configured to communicate with a wireless device, WD, the method comprising:
transmitting a first configuration to the WD, the first configuration being for an interference plus noise, IpN, measurement associated with a first channel and based on one or more parameters, the IpN measurement to be performed by the WD;
transmitting a data transmission to the WD on the first channel; and
receiving a first measurement report from the WD, the first measurement report comprising the IpN measurement associated with the first channel.

26. The method of claim 25, wherein the first configuration includes an interference measurement resource, IMR, for reception of the first channel.

27. The method of claim 26, wherein the IpN measurement is performed on the IMR.

28. The method of claim 26, wherein one or both of:
the IMR configures residual demodulation reference signal, DMRS; and
when the WD has performed a channel estimation on the DMRS associated with the first channel, the IpN is estimated on one or more DMRS resources.

29. The method of claim 25, wherein the IpN measurement is a power measurement of received power in one or more empty resource elements in a resource allocation of the first channel.

30. The method of claim 29, wherein the received power is normalized with respect to another measurement that reflects a desired channel.

31.-35. (canceled)

36. A network node configured to communicate with a wireless device, WD, the network node being configured to:
transmit a first configuration to the WD, the first configuration being for an interference plus noise, IpN, measurement associated with a first channel and based on one or more parameters, the IpN measurement to be performed by the WD;
transmit a data transmission to the WD on the first channel; and
receive a first measurement report from the WD, the first measurement report comprising the IpN measurement associated with the first channel.

37.-46. (canceled)
